(19) United States
(12) Patent Application Publication
(10) Pub. No.: US 2022/0308949 A1
(43) Pub. Date: Sep. 29, 2022

(54) PUBLISHING SYSTEM, PUSHING METHOD, APPLICATION DEVICE, RECEIVING DEVICE AND SERVICE MANAGEMENT DEVICE

(71) Applicant: BOE TECHNOLOGY GROUP CO., LTD., Beijing (CN)

(72) Inventors: Weiwei LIU, Beijing (CN); Xiaozhong CHANG, Beijing (CN)

(21) Appl. No.: 17/293,641

(22) PCT Filed: Jun. 24, 2020
(86) PCT No.: PCT/CN2020/098144

§ 371 Date: May 13, 2021

(51) Int. Cl. G06F 9/54; G06F 8/41; G06F 8/20

(52) U.S. Cl. CPC G06F 9/547; G06F 8/427; G06F 8/24

(57) ABSTRACT

There is provided an API publishing system, in which an application device includes a first storage module having a first executable program stored thereon, and a first processor capable of calling the first executable program to acquire API characteristic information, generate a standard API document, and push the standard API document to a receiving device; the receiving device includes a second storage module having a second executable program stored thereon, and a second processor capable of calling the second executable program to acquire and parse the standard API document; and a service management device includes a third storage module having a third executable program stored thereon, and a third processor capable of receiving and displaying the API characteristic information. An API information pushing method, an acquisition method for API characteristic information, an API publishing method, an application device, a receiving device and a service management device are further provided.

### TECHNICAL FIELD

The present disclosure relates to the field of middleground technologies, and in particular, to an application programming interface (API) publishing system, an API information pushing method, an acquisition method for API characteristic information, an API publishing method, a computer-readable storage medium, an application device, a service management device, and a receiving device.

### BACKGROUND

In the construction of a middleground system, it is necessary to publish API services with shared attributes, such as a short message platform, a user center, a dormitory management system, and a message notifier, on a service governance platform, so that the API services can be displayed for users to check, and can be conveniently called by the users in their respective system development, thereby reducing cost of repeated development, and improving utilization of the shared API services.

### SUMMARY

The present disclosure aims to provide an API publishing system, an API information pushing method, an API publishing method, a computer-readable storage medium, an application device, and a service management device.

In a first aspect of the present disclosure, there is provided an API publishing system, including a receiving device, a service management device, and at least one application device,

the application device includes:

a first storage module having a first executable program stored thereon; and

one or more first processors capable of calling the first executable program to perform the following operations:
acquiring API characteristic information of an application program in response to a start signal of the application program;
generating a standard API document according to the API characteristic information; and
pushing the standard API document to the receiving device;

the receiving device includes:

a second storage module having a second executable program stored thereon; and

one or more second processors capable of calling the second executable program to perform the following operations:
acquiring the standard API document; and
parsing the standard API document to obtain the API characteristic information;

the service management device includes:

a third storage module having a third executable program stored thereon; and

one or more third processors capable of calling the third executable program to perform the following operation:
receiving and displaying the API characteristic information obtained through parsing by the receiving device.

In some embodiments, the step of acquiring the standard API document by the receiving device includes:

filtering the information received by the receiving device to obtain the standard API document.

In some embodiments, the API characteristic information includes at least one of class annotation of API, interface annotation of API, parameter annotation of API, parameter object annotation of API, configuration table of API, and interface address of API.

In some embodiments, the first executable program is further configured to be called by the first processor to enable the first processor to perform the following operation:

stopping acquiring the API characteristic information after pushing the standard API document to the receiving device.

In some embodiments, the second executable program is further configured to be called by the second processor to enable the second processor to perform the following operation:

storing the standard API document in a cache of the receiving device before parsing the standard API document.

In some embodiments, the second executable program is further configured to be called by the second processor to enable the second processor to perform the following operation:

adding a default value for the API characteristic information obtained through parsing.

In some embodiments, the second executable program is further configured to be called by the second processor to enable the second processor to perform the following operation:

comparing the API characteristic information received by the receiving device with locally stored API characteristic information to determine whether an API corresponding to the API characteristic information changes.

In some embodiments, a change of the API includes an update of an existing API or addition of a new API.

In some embodiments, the second executable program is further configured to be called by the second processor to enable the second processor to perform the following operation:

storing the API characteristic information locally in the receiving device.

In some embodiments, the application program includes at least one of a short message platform, a user center, a dormitory management system, and a message notifier.

In a second aspect of the present disclosure, there is provided an API information pushing method applied to an application device, including:

acquiring API characteristic information of an application program in response to a start signal of the application program;

generating a standard API document according to the API characteristic information; and

pushing the standard API document to a receiving device.

In some embodiments, the API characteristic information includes at least one of class annotation of API, interface annotation of API, parameter annotation of API, parameter object annotation of API, configuration table of API, and interface address of API.

In some embodiments, the pushing method further includes:

stopping acquiring the API characteristic information after pushing the standard API document to the receiving device.

In a third aspect of the present disclosure, there is provided an acquisition method for API characteristic information applied to a receiving device, including:

filtering received information to obtain a standard API document; and

parsing the standard API document to obtain API characteristic information.

In some embodiments, the acquisition method further includes:

adding a default value for the API characteristic information obtained through parsing.

In some embodiments, the acquisition method further includes:

after obtaining the API characteristic information, comparing the API characteristic information with locally stored API characteristic information to determine whether an API corresponding to the API characteristic information changes.

In some embodiments, a change of the API includes an update of an existing API or addition of a new API.

In some embodiments, the acquisition method further includes:

persistently and locally storing the API characteristic information.

In some embodiments, the acquisition method further includes:

before parsing the standard API document, storing the standard API document in a cache.

In a fourth aspect of the present disclosure, there is provided an API publishing method applied to a service management device, including:

receiving API characteristic information obtained through parsing by a receiving device, with the API characteristic information obtained by the above acquisition method; and

displaying the API characteristic information.

In a fifth aspect of the present disclosure, there is provided a computer-readable storage medium having an executable program stored thereon, and any one of the following methods can be performed when the executable program is called:

the pushing method provided in the second aspect of the present disclosure;

the acquisition method provided in the third aspect of the present disclosure; and

the API publishing method provided in the fourth aspect of the present disclosure.

In a sixth aspect of the present disclosure, there is provided an application device, including:

a first storage module having a first executable program stored thereon; and

one or more first processors capable of calling the first executable program to perform the pushing method provided in the second aspect of the present disclosure.

In a seventh aspect of the present disclosure, there is provided a receiving device, including:

a second storage module having a second executable program stored thereon; and

one or more second processors capable of calling the second executable program to perform the acquisition method provided in the third aspect of the present disclosure.

In an eighth aspect of the present disclosure, there is provided a service management device, including:

a third storage module having a third executable program stored thereon; and

one or more third processors capable of calling the third executable program to perform the API publishing method provided in the fourth aspect of the present disclosure.

### BRIEF DESCRIPTION OF THE DRAWINGS

The accompanying drawings are intended to provide further understanding of the present disclosure and are incorporated in and constitute a part of the specification. The drawings, together with the following specific embodiments, are intended to explain the present disclosure, but do not impose any limitation on the present disclosure. In the drawings:

FIG. 1 is a block diagram of an API publishing system according to an embodiment of the present disclosure;

FIG. 2 is a schematic diagram of a page provided by a service management device in an API publishing system provided by the present disclosure;

FIG. 3 is a flowchart illustrating a pushing method provided by the present disclosure;

FIG. 4 is a flowchart illustrating an acquisition method provided by the present disclosure;

FIG. 5 is a flowchart illustrating a publishing method provided by the present disclosure;

FIG. 6 is a schematic diagram illustrating interaction between an application device and a receiving device in the API publishing system provided by the present disclosure; and

FIG. 7 is a schematic diagram illustrating how a user acquires services through the API publishing system.

### DETAILED DESCRIPTION

The specific embodiments of the present disclosure are described in detail below in conjunction with the accompanying drawings. It should be understood that the specific embodiments descried herein are merely intended to illustrate and explain the present disclosure, rather than limiting the present disclosure.

An API includes some predefined functions, and is configured to provide applications and developers with the capability to access a set of routines based on certain software or hardware without accessing source code or understanding details of internal operation mechanisms.

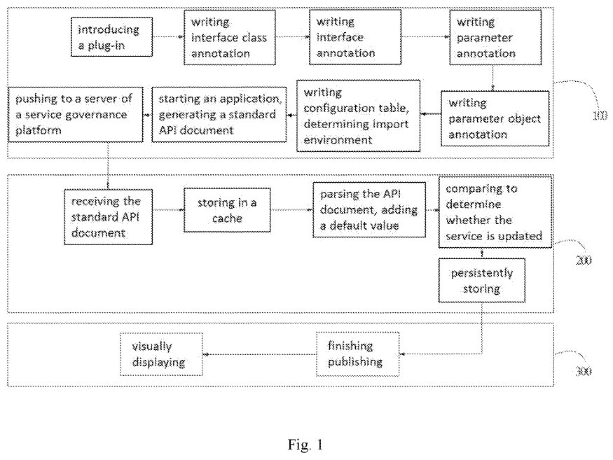

In a first aspect of the present disclosure, there is provided an API publishing system, and as shown in FIG. 1, the API publishing system includes a receiving device 200, a service management device 300, and at least one application device 100.

An application device can run application programs. The application device 100 in the present disclosure includes:

a first storage module having a first executable program stored thereon; and

one or more first processors capable of calling the first executable program to perform the following operations:

acquiring API characteristic information of an application program in response to a start signal of the application program;

generating a standard API document according to the API characteristic information; and

pushing the standard API document to the receiving device.

The receiving device 200 includes:

a second storage module having a second executable program stored thereon; and

one or more second processors capable of calling the second executable program to perform the following operations:

acquiring the standard API document; and

parsing the standard API document to obtain the API characteristic information.

The service management device 300 includes:

a third storage module having a third executable program stored thereon; and

one or more third processors capable of calling the third executable program to perform the following operation:

displaying the API characteristic information.

The API publishing system provided by the present disclosure includes at least one application device 100, and the first executable program in each application device 100 is a plug-in that is associated with one or more application programs installed in the application device 100. The plug-in can perform the above operations of acquiring API characteristic information, generating one or more corresponding standard API documents, and pushing the standard API document to the receiving device 200 on the one or more application programs which are installed in the application device 100 and associated with the plug-in. Moreover, the API standard document may include one or more pieces of API information.

In the present disclosure, no particular limitation is imposed on how to generate the standard API document.

In an alternative embodiment, the standard API document can be generated with the following method:

when an application program associated with the plug-in is started, an API creation thread is initiated through a startup class built in a framework of the application program;

a main thread continues to execute a startup logic, and the API creation thread processes corresponding logic asynchronously;

the plug-in acquires an associated interface and annotation information through a reflection logic of the framework of the application program, and performs splicing and packaging to a certain extent to form an API object; and

a plurality of API objects are combined and converted to form a JSON array which is the standard API document.

It should be noted that the reflection logic refers to the capability to know all attributes and methods of any class and to call any method of any object in a running state. A reflection mechanism in Java language refers to a function of dynamically acquiring information and dynamically calling a method of an object.

The second executable program in the receiving device 200 is an automatic receiving program, and can filter all received information to remove incomplete information and the data that do not meet the format requirement of the standard API document, so as to only keep the standard API document. In addition, the receiving device can parse the standard API document to obtain the API characteristic information for the service management device 300 to display.

In the present disclosure, the application device 100 can acquire the corresponding API characteristic information as long as the application program is started, so that the receiving device 200 can always receive the standard API document including the latest version of API characteristic information, which ensures that the service management device 300 can display the latest version of API.

In the present disclosure, no particular limitation is imposed on the step of parsing the standard API document. In some embodiments, after receiving the API information through the interface, the receiving program first stores the API information in a cache, and the interface returns a stateless symbol; and thread monitoring is performed, JSON as an object is parsed when it is found through the thread monitoring that new data are stored in the cache, invalid data is cleared, input/output parameter formats are converted, basic service attribute information is updated, a default value is added, comparison is performed to determine whether the addition or an update occurs, and the data are persistently stored in a database.

An application developer sends APIs of applications which run on the application device 100 to the service management device 300 for users to check. In the related art (such as swagger), the service management device 300 can actively send an API acquisition or updating request to the application device 100 at any time, and scan related application code through swagger to obtain related API document information, which poses a risk of code intrusion. In the present disclosure, the application device 100 actively pushes the API standard document carrying the API characteristic information to the receiving device 200, which reduces or even eliminates the risk of code intrusion into the application device 100 and a risk of tampering of data in the application device 100, thereby improving the security of the application device 100.

Furthermore, it is designed in the present disclosure that the receiving device 200 including the second executable program (i.e., the automatic receiving program) receives the standard API document and operates independent of the application device 100 and the service management device 300, without affecting the operation of the application program in the application device 100 or the operation of the service management device 300.

For the convenience of maintenance, in an alternative embodiment, the receiving device 200 and the service management device 300 can be disposed at a same site in a network.

In the present disclosure, the first executable program (i.e., the plug-in) installed in the application device 100 can perform the operations such as acquiring API characteristic information, generating a standard API document according to the API characteristic information, and pushing the standard API document to the receiving device. After an application program finishes defining the API characteristic information thereof, the plug-in is triggered when the application program is started so as to collect the API characteristic information through a reflection mechanism, and the API characteristic information is sorted and encoded to form the standard API document.

The method of generating the standard API document is described above and thus will not be repeated here.

In an alternative embodiment, the plug-in pushes the standard API document only once when the application program is started. That is, after the standard API document is pushed to the receiving device 200, the plug-in stops collecting and acquiring the API characteristic information. Accordingly, since the plug-in is triggered only once when the application program is started, the risk that the software such as swagger arbitrarily invades the application code to acquire the API characteristic information during the operation of the application program can be avoided.

In the present disclosure, no particular limitation is imposed on how to push the standard API document to the receiving device 200. The second executable program (i.e., the receiving program) is installed in the receiving device 200 to perform the above steps of “filtering the received information to obtain the standard API document, parsing the standard API document to obtain the API characteristic information”. In some embodiments, when the application device 100 pushes the standard API document to the receiving device 200, the API of the receiving program is called to push the standard API document to the interface of the receiving program.

In the present disclosure, no particular limitation is imposed on the specific content of the API characteristic information, as long as users can call the corresponding application program according to the API characteristic information displayed in the service management device 300 and the address acquired by the service management device 300.

In an alternative embodiment, the API characteristic information includes at least one of class annotation of API, interface annotation of API, parameter annotation of API, parameter object annotation of API, configuration table of API, and interface address of API.

Furthermore, in some embodiments, the class annotation includes at least one of publisher information, field to which an API belongs, and class to which an API belongs.

In the present disclosure, no particular limitation is imposed on the specific content of the interface annotation. In some embodiments, the interface annotation may include at least one of name information of API, service description information of API, internal/external attribute of API, rate limit attribute of API, and public API information of API.

In the present disclosure, no particular limitation is imposed on the content of the parameter annotation. In some embodiments, the parameter annotation includes at least one of parameter name, parameter description, default value of parameter, instance value of parameter, an attribute indicating whether a parameter is mandatory, and parameter type.

In the present disclosure, no particular limitation is imposed on the specific content of the parameter object annotation. In some embodiments, the parameter object annotation includes at least one of parameter path, parameter name, parameter description, default value of parameter, instance value of parameter, and parameter type, an attribute indicating whether a parameter is mandatory, and type of access protocol.

Restful interface parameters typically include service interface information and parameter information. In order to meet basic requirements of service attributes of a service governance platform, the present disclosure defines a set of API document generation specifications including the API characteristic information, which ensures integrity and normalization of service attributes, and also ensure the scalability when the service governance platform is upgraded later or in other application scenarios.

The service management device 300 performs unified classification and management on a plurality of APIs thereon according to the API characteristic information. Therefore, on the one hand, users can check the APIs on the platform conveniently, and on the other hand, the service management device 300 can set permissions for corresponding fields, so that only the users in the corresponding fields can have the permission to subscribe to or call the related APIs.

For example, the service management device 300 can limit the identities and the permissions of subscribers according to the publisher information, the field to which an API belongs, and the class to which an API belongs. For example, when the publisher information of an API indicates that the publisher is a financial staff, the service management device 300 only allows finance-related users to subscribe to the corresponding API. When an API belongs to the field of human resource (HR) management, the service management device 300 only allows HR-related users to subscribe to the corresponding API. The service governance platform can set whether an API document is made publicly available according to the internal/external attribute or the public API information of the API document.

In an alternative embodiment, the application program in the application device has a shared attribute, that is, the application program can be called in multiple systems, such as a short message platform, a user center, and a message notifier, and the like. With the API corresponding to the shared application published on the service management device 300, users can directly call the application according to the related API information in the service management device 300 when designing an application program or system, thereby avoiding repeated development.

The receiving device 200 may not obtain the API information due to unstable network conditions or unstable states of the receiving device 200.

In the case where the receiving device 200 cannot receive the standard API document due to the unstable network conditions and thus cannot obtain the API information, the first executable program (i.e., the plug-in) installed in the application device 100 receives a transmission failure message for the publisher of the application program to perform troubleshooting or other processes accordingly. In order to provide services more smoothly, the application device 100 continues to run the application program when receiving the transmission failure message. That is, the plug-in of the application device 100 provides a non-interference service, and can provide stable application service no matter the standard API document is successfully pushed or not, without affecting the normal operation of the application program.

After the application program in the application device 100 is restarted, the standard API document which fails to be sent is pushed again.

In an alternative embodiment, the first executable program of the receiving device 200 operates independent of the system of the service management device 300 and has highly reliable settings. After receiving the API document information, the receiving device 200 immediately stores the API document information in a cache, such as in a Redis database. In the subsequent parsing and other operations, the corresponding API document information can be found in the cache without requesting the application device to re-send the API document information even if the API document information is lost due to the unstable system or other unstable states of the receiving device 200.

When the service management device 300 displays the API, the parameters to be displayed may be more than those acquired through the parsing of the standard API document by the receiving device 200. In an alternative embodiment, the API characteristic information acquired through the parsing is directly displayed by the service management device 300. In another alternative implementation, the receiving device 200 adds a default value for the API characteristic information acquired through the parsing. Correspondingly, the service management device 300 displays the API characteristic information the default value of which is added. It should be understood that the API characteristic information may be the information directly acquired by parsing the API document, or the information acquired by parsing the API document and adding the default value.

In the present disclosure, no particular limitation is imposed on the default value added by the receiving device 200. For example, the default value may be of the rate limit attribute. The default values may be set according to the field to which the application program corresponding to the API belongs and the unique identifier of the application program. For example, in the case where the default value is of the rate limit attribute, the default value of the rate limit attribute may be “no rate limit” for the APIs corresponding to some applications. As described above, the API publishing system provided by the present disclosure can ensure that the API displayed by the service management device is always the latest version.

In an embodiment of the present disclosure, the receiving device 200 is further configured to determine whether a change of an API occurs.

Specifically, the second executable program of the receiving device 200 is further configured to be called by the second processor to enable the second processor to perform the following operations: comparing the API characteristic information with locally stored API characteristic information to determine whether the API corresponding to the API characteristic information changes.

In the present disclosure, the change of an API includes an update of an existing API and addition of a new API. That is, the application device 100 can publish a new API through the plug-in, and can also update an API through the plug-in.

Correspondingly, the second executable program of the receiving device 200 is further configured to be called by the second processor to enable the second processor to perform the following operation:

comparing the API characteristic information with the locally stored API characteristic information to determine whether the API corresponding to the API characteristic information changes.

Specifically, each API corresponds to a service name. The receiving device 200 can compare the API service name in the extracted API characteristic information with a locally stored API service name, and determine that the API corresponding to the API service name in the extracted API characteristic information is a new API when the API service name in the extracted API characteristic information is not locally stored.

In addition, the receiving device 200 is further configured to compare the API characteristic information locally stored in the receiving device 200 with the received API characteristic information when it is determined that the received API characteristic information belongs to an existing API, determine that the existing API is updated when the comparison result indicates that the locally stored API characteristic information and the received API characteristic information do not match, and integrate the updated API characteristic information with the existing API information.

In order to facilitate parsing the standard API document, in some embodiments, the receiving device may store the received standard API document in a cache of the receiving device 200 before parsing the standard API document.

After the standard API document is processed and the API characteristic information is obtained, the API characteristic information may be persistently and locally stored in the receiving device 200, such as in a MySQL database.

In addition to the functions of serving as a data source of an API gateway, displaying characteristic information of an API and acquiring an address, the service management device 300 provided by the present disclosure may further provide a function of debugging an API on a web page. Specifically, the service management device is configured to test a corresponding API according to an API debugging instruction.

In order to improve the security, in some embodiments, the service management device 300 is further configured to perform authentication on a subsequent call of API gateway. Specifically, the service management device 300 is further configured to perform authentication on a gateway which issues an API call instruction according to the API call instruction. The API gateway is allowed to call the corresponding API only if the API gateway is authenticated.

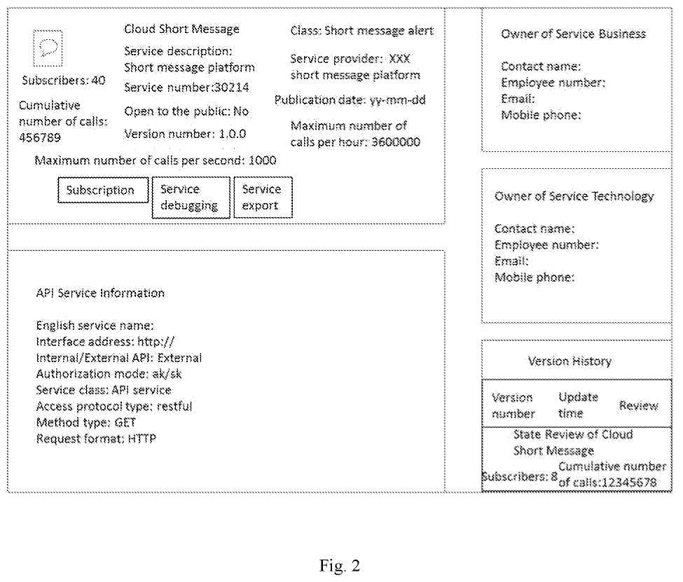

As described above, the service management device 300 can display the API information of an API and acquire an address. The content displayed by the service management device 300 is described in detail below with reference to FIG. 2.

FIG. 2 shows the information related to an API of an application “Cloud Short Message”. As shown in FIG. 2, the service management device 300 provides a display page that presents the information of an API corresponding to the application program “Cloud Short Message” and the information related to the “Cloud Short Message”. For example, the content displayed on the page includes six parts, which are:

basic information of the application program “Cloud Short Message”, including service description (e.g, short message platform), class (e.g, short message alert), service number (e.g, 30214), service provider (e.g, xxx short message platform), open to the public (e.g, no), publication date (e.g, yy-mm-dd), version number (e.g, 1.0.0), maximum number of calls per second (e.g, 1000), and maximum number of calls per hour (e.g, 3600000);

information of owner of service business, including contact name, employee number of contact, contact email, and contact mobile phone;

information of owner of service technology, including contact name, employee number of contact, contact email, and contact mobile phone;

API service information, including English service name, interface address of API, internal/external API (e.g, whether the API is an internal API or an external API, and the API of the “Cloud Short Message” is an external API), authorization mode (e.g, ak/sk authentication), service class (e.g, API service), access protocol type (e.g, restful), method type (e.g, GET), and request format (e.g, HTTP);

version history, including version number, update time, and entry to version history; and

state review of Cloud Short Message: number of subscribers (e.g, 8), and cumulative number of calls (e.g, 123456789).

It should be noted that a subscription entry, a service debugging entry, and a service export entry are also provided on the above display page. A user can debug the API through the service debugging entry on the page, export a standard API document through the service export entry, and subscribe to the API through the subscription entry.

In addition to the above display function, the service management device 300 may further support a fuzzy search function in the visualized page, so as to allow a user to acquire required services from the service management device 300, and thus reduce the workload of operation and maintenance staff/service staff.

For example, APIs of the application “Cloud Short Message” and the application “Group Text Message” are stored in the service management device 300, so that the search results of an input “message” in the visualized page provided by the service management device 300 can include two search results, namely “Cloud Short Message” and “Group Text Message”.

As a data source and a management system of an API gateway, the service management device 300 can manage a service relationship and a subscription relationship.

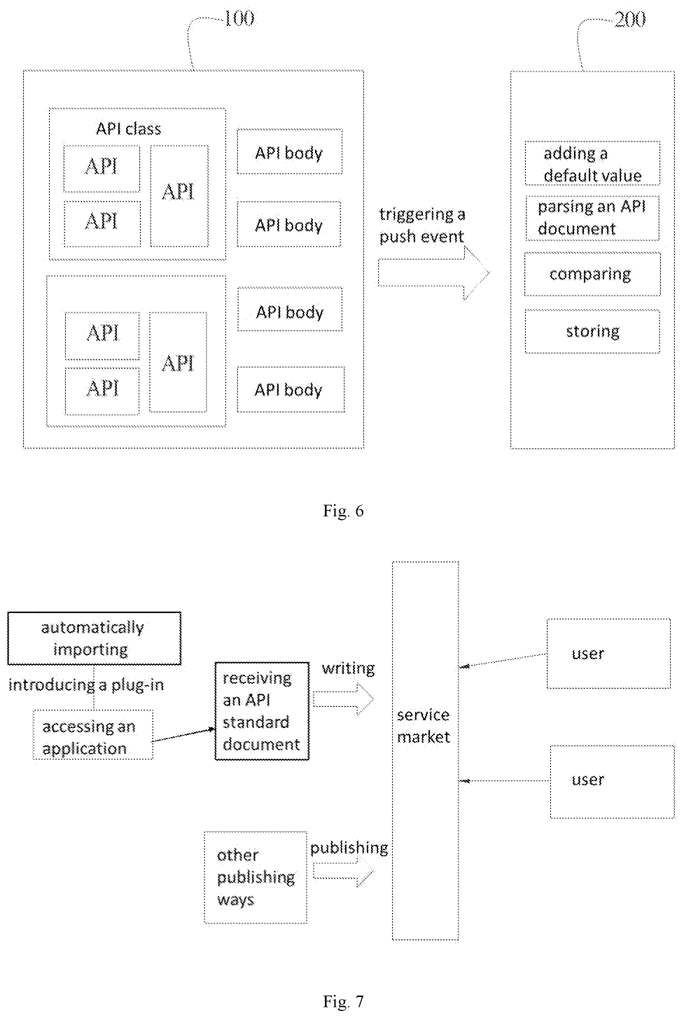

An operation process of the API publishing system according to an alternative embodiment of the present disclosure is described in detail below with reference to FIGS. 6 and 7.

Firstly, the first executable program (i.e., the plug-in), which can perform the steps of acquiring API characteristic information in response to a start signal of an application program, generating a standard API document according to the API characteristic information, and pushing the standard API document to the receiving device”, is introduced into the application device 100 to acquire all the characteristic information defined in an API class by the application program. After the API characteristic information needed is acquired, a standard API document is generated, the API of the second executable program (i.e., the receiving program) installed in the receiving device 200 is called, and a push event is triggered to push the standard API document to the receiving device 200.

After the receiving device 200 receives the standard API document, the standard API document is parsed through calling the second executable program to acquire the API characteristic information, and the API characteristic information acquired by the parsing is added with the default value. The API characteristic information acquired by the receiving device 200 is compared with locally stored information to determine whether a change of an API occurs, and is stored locally in the receiving device 200. Meanwhile, the receiving device 200 pushes the API information to the service management device 300, so that the service management device can visualize and display the API information in the form of a service market.

When a user (i.e., an application developer) wants to publish an API of an application in a service market, the user first downloads a relevant plug-in (i.e., the first executable program) to a system server (the application device 100) of the user, a plug-in event is triggered when the application is started, a standard API document is generated and is sent to the receiving device in which a receiving program (i.e., the second executable program) is installed, and the standard API document is processed by the receiving program and then published in the service market for other users to check and call.

The user can also check the API documents provided by the other users in the service market, and call the API documents or perform other operations on the API documents. In addition to adopting the way of triggering the plug-in event, the user can manually fill in a standard API document template provided by the service market and then send the finished standard API document to the service market to publish an API.

It should be noted that the application device may be a server terminal of a user, the service governance platform may also be a server terminal, and both the application device and the service governance platform may be cloud systems.

In a second aspect of the present disclosure, there is provided an API information pushing method applied to the application device 100. As shown in FIG. 2, the information pushing method includes:

at step S110, acquiring API characteristic information in response to a start signal of an application program;

at step S120, generating a standard API document according to the API characteristic information; and

at step S130, pushing the standard API document to a receiving device.

In some embodiments, the API characteristic information includes at least one of class annotation of API, interface annotation of API, parameter annotation of API, parameter object annotation of API, configuration table of API, and interface address of API.

With the information pushing method provided by the present disclosure, the standard API document carrying the API characteristic information of the application program can be actively pushed to the receiving device 200, and the receiving device 200 can provide the latest version of the API characteristic information for the service management device 300, so that the service management device 300 can always display the latest version of the API, which reduces or even eliminates the risk of code intrusion into the application device 100 and the risk of tampering of data in the application device 100, thereby improving the security of the application device 100.

The information pushing method may be implemented by a plug-in installed in the application device 100. After an application program installed in the application device 100 finishes defining the API characteristic information, a plug-in event is triggered when the application program is started so as to collect, sort and encode the API characteristic information through a reflection principle to form a standard API document, and then the standard API document is pushed to the receiving device.

Correspondingly, an automatic receiving program (i.e., the above second executable program) is installed in the receiving device to achieve automatic receiving of the API document.

When the system of the application device begins to operate, it is hard to modify codes again, that is, the codes are always kept in a latest state during the operation. Therefore, by carrying out the pushing method during the operation of the system of the application device, it can be ensured by only one push that the interface service displayed by the service management device 300 can be always kept in a latest state, which guarantees effectiveness and timely synchronization of the service.

Correspondingly, the pushing method may further include:

at step S140, stopping acquiring the API characteristic information after pushing the standard API document to the receiving device.

The standard API document may not be normally received by the receiving device 200 under certain network situations or due to system stability of the application device. In such case, the pushing method may further include:

at step S150, re-sending the standard API document to the receiving device in response to a push failure message and a restart signal of the application program.

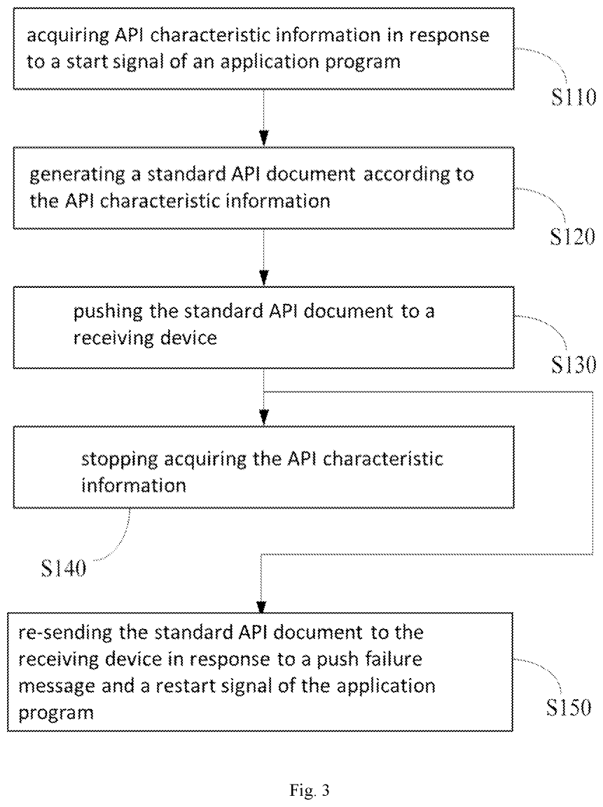

In a third aspect of the present disclosure, there is provided an acquisition method for API characteristic information, which is applied to the receiving device 200. As shown in FIG. 3, the acquisition method includes:

at step S210, filtering received information to obtain a standard API document; and

at step S220, parsing the standard API document to obtain API characteristic information.

The acquisition method provided by the present disclosure is performed by the receiving device 200. After receiving the standard API document, the receiving device 200 performs the step S210 and the step S220 independent of the application device 100 and the service management device 300, without affecting the operation of the application program in the application device 100 or the operation of the service management device 300.

In some embodiments, the acquisition method may further include:

at step S230, adding a default value for the API characteristic information obtained through parsing.

As described above, the default value may be of a rate limit attribute.

In some embodiments, after the step S220, the acquisition method further includes:

at step S240, comparing the API characteristic information with locally stored API characteristic information to determine whether the API corresponding to the API characteristic information changes.

In the present disclosure, a change of an API includes an update of an existing API and addition of a new API. That is, the application device 100 can publish a new API through the plug-in, and can also update an API through the plug-in.

Correspondingly, the receiving device 200 is further configured to compare the API characteristic information with the locally stored API characteristic information to determine whether the API corresponding to the API characteristic information changes.

Specifically, each API corresponds to a service name. The receiving device 200 can compare the API service name in the extracted API characteristic information with a locally stored API service name, and determine that the API corresponding to the API service name in the extracted API characteristic information is a new API when the API service name in the extracted API characteristic information is not locally stored.

In order to facilitate parsing the standard API document, in some embodiments, the acquisition method further includes:

at step S250, persistently and locally storing the API characteristic information.

In order to ensure that the API information can be provided for a service management device, in some embodiments, the acquisition method includes:

at step S260, locally storing the standard API document when the standard API document fails to be received.

In order to facilitate parsing the standard API document, in some embodiments, the acquisition method further includes:

storing the standard API document in a cache before parsing the standard API document.

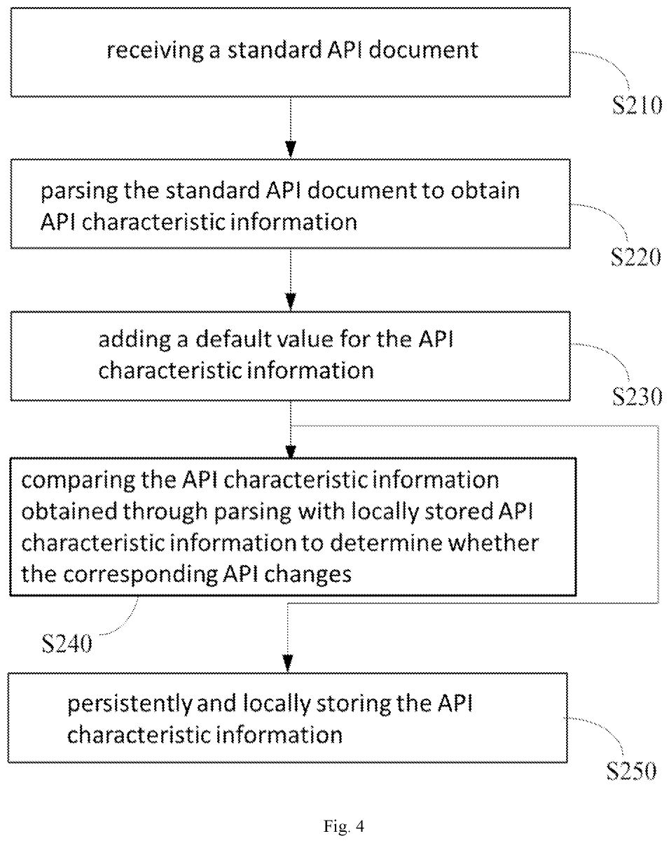

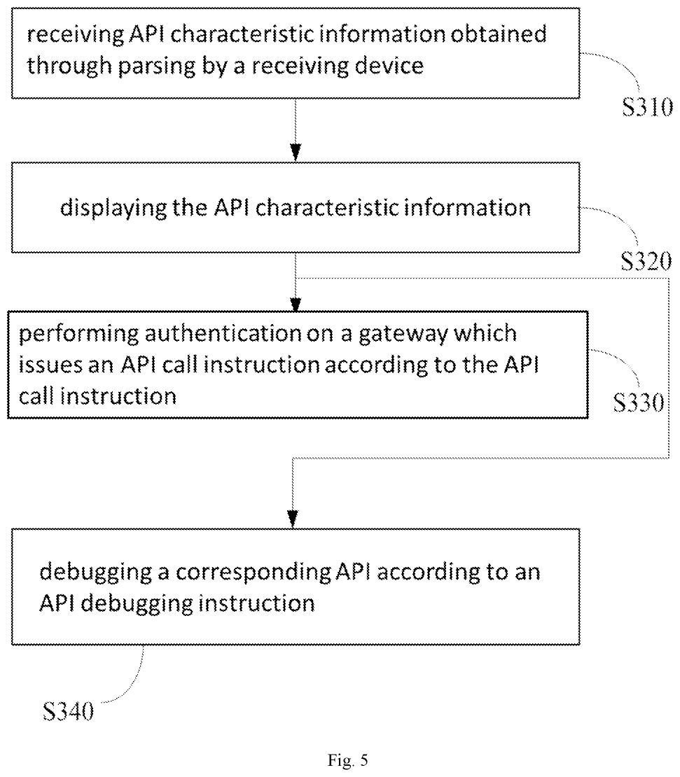

In a fourth aspect of the present disclosure, there is provided an API publishing method performed by the service management device 300. As shown in FIG. 4, the API publishing method includes:

at step S310, receiving API characteristic information obtained through parsing by a receiving device; and

at step S320, displaying the API characteristic information.

As described above, an API is visually displayed by the service management device 300 with the above method for users to check and subscribe to.

In some embodiments, the API publishing method further includes:

at step S330, performing authentication on a gateway which issues an API call instruction according to the API call instruction; and/or

at step S340, debugging a corresponding API according to an API debugging instruction.

In a fifth aspect of the present disclosure, there is provided a computer-readable storage medium having an executable program stored thereon, and any one of the following methods can be performed when the executable program is called:

the pushing method provided in the second aspect of the present disclosure;

the acquisition method provided in the third aspect of the present disclosure; and

the API publishing method provided in the fourth aspect of the present disclosure.

It should be understood by those of ordinary skill in the art that all or some of the steps in the methods disclosed above, the functional modules/units in the systems and the devices disclosed above may be implemented as software, firmware, hardware, or suitable combinations thereof. If implemented as hardware, the division between the functional modules/units stated above is not necessarily corresponding to the division of physical components; for example, one physical component may have a plurality of functions, or one function or step may be performed through cooperation of several physical components. Some or all of the physical components may be implemented as software executed by a processor, such as a central processing unit, a digital signal processor or a microprocessor, or be implemented as hardware, or be implemented as an integrated circuit, such as an application specific integrated circuit. Such software may be distributed on computer-readable medium, which may include computer storage medium (or non-transitory medium) and communication medium (or transitory medium). As well known by those skilled in the art, the term “computer storage medium” includes volatile/nonvolatile and removable/non-removable medium used in any method or technology for storing information (such as computer-readable instructions, data structures, program modules and other data). The computer storage medium include, but are not limited to, random-access memories (RAMs), read-only memories (ROMs), electrically erasable programmable read-only memories (EEPROMs), flash memories or other memory techniques, compact disc read-only memories (CD-ROMs), digital video disks (DVDs) or other optical discs, magnetic cassettes, magnetic tapes, magnetic disks or other magnetic storage devices, or any other medium which can be used to store the desired information and can be accessed by a computer. In addition, it is well known by those skilled in the art that the communication medium generally includes computer-readable instructions, data structures, program modules or other data in a modulated data signal, such as a carrier wave or other transmission mechanism, and may include any information delivery medium.

In a sixth aspect of the present disclosure, there is provided an application device, including:

a first storage module having a first executable program stored thereon; and

one or more first processors capable of calling the first executable program to perform the pushing method provided in the second aspect of the present disclosure.

The application device may further include one or more first I/O interfaces coupled between the first processor and the first storage module and configured to enable information interaction between the first processor and the first storage module.

The first processor is a device with data processing capability, and includes, but is not limited to, a central processing unit (CPU); and the first storage module is a device with data storage capability, and includes, but is not limited to, an RAM (more specifically, a synchronous dynamic random-access memory (SDRAM), a double data rate (DDR) SDRAM, etc.), an ROM, an EEPROM, and a flash memory.

The first I/O interface is coupled between the first processor and the first storage module, and can enable the information interaction between the first processor and the first storage module. The first I/O interface includes, but is not limited to, a data bus.

In some embodiments, the first processor, the first storage module, and the first I/O interface are coupled to each other via a bus and then are coupled to other components of a display terminal.

In a seventh aspect of the present disclosure, there is provided a receiving device, including:

a second storage module having a second executable program stored thereon; and

one or more second processors capable of calling the second executable program to perform the acquisition method provided in the third aspect of the present disclosure.

The receiving device may further include one or more second I/O interfaces coupled between the second processor and the second storage module and configured to enable information interaction between the second processor and the second storage module.

The second processor is a device with data processing capability, and includes, but is not limited to, a CPU; and the second storage module is a device with data storage capability, and includes, but is not limited to, an RAM (more specifically, an SDRAM, a DDR SDRAM, etc.), an ROM, an EEPROM, and a flash memory.

The second I/O interface is coupled between the second processor and the second storage module, and can enable the information interaction between the second processor and the second storage module. The second I/O interface includes, but is not limited to, a data bus.

In some embodiments, the second processor, the second storage module, and the second I/O interface are coupled to each other via a bus and then are coupled to other components of a display terminal.

In an eighth aspect of the present disclosure, there is provided a service management device, including:

a third storage module having a third executable program stored thereon; and

one or more third processors capable of calling the third executable program to perform the API publishing method provided in the fourth aspect of the present disclosure.

The service management device may further one or more third I/O interfaces coupled between the third processor and the third storage module and configured to enable information interaction between the third processor and the third storage module.

The third processor is a device with data processing capability, and includes, but is not limited to, a CPU; and the third storage module is a device with data storage capability, and includes, but is not limited to, an RAM (more specifically, an SDRAM, a DDR SDRAM, etc.), an ROM, an EEPROM, and a flash memory.

The third I/O interface is coupled between the third processor and the third storage module, and can enable the information interaction between the third processor and the third storage module. The third I/O interface includes, but is not limited to, a data bus.

In some embodiments, the third processor, the third storage module, and the third I/O interface are coupled to each other via a bus and then are coupled to other components of a display terminal.

It should be understood that the above embodiments are merely exemplary embodiments employed to illustrate the principle of the present disclosure, and the present disclosure is not limited thereto. Those of ordinary skill in the art can make various changes and improvements without departing from the spirit and essence of the present disclosure, and those changes and improvements should be considered to fall within the protection scope of the present disclosure.

1. An application programming interface publishing system, comprising a receiving device, a service management device, and at least one application device,
the application device comprises:
a first storage module having a first executable program stored thereon; and
one or more first processors capable of calling the first executable program to perform following operations:
acquiring application programming interface characteristic information of an application program in response to a start signal of the application program;
generating a standard application programming interface document according to the application programming interface characteristic information; and
pushing the standard application programming interface document to the receiving device;
the receiving device comprises:
a second storage module having a second executable program stored thereon; and
one or more second processors capable of calling the second executable program to perform following operations:
acquiring the standard application programming interface document; and
parsing the standard application programming interface document to obtain the application programming interface characteristic information;
the service management device comprises:
a third storage module having a third executable program stored thereon; and
one or more third processors capable of calling the third executable program to perform following operations:
receiving and displaying the application programming interface characteristic information obtained through parsing by the receiving device.

2. The application programming interface publishing system of claim 1, wherein the acquiring the standard application programming interface document by the receiving device comprises:
filtering information received by the receiving device to obtain the standard application programming interface document.

3. The application programming interface publishing system of claim 1, wherein the application programming interface characteristic information comprises at least one of class annotation of application programming interface, interface annotation of application programming interface, parameter annotation of application programming interface, parameter object annotation of application programming interface, configuration table of application programming interface, and interface address of application programming interface.

4. The application programming interface publishing system of claim 1, wherein the first executable program is further configured to be called by the first processor to enable the first processor to perform a following operation:
stopping acquiring the application programming interface characteristic information after pushing the standard application programming interface document to the receiving device.

5. The application programming interface publishing system of claim 1, wherein the second executable program is further configured to be called by the second processor to enable the second processor to perform a following operation:
storing the standard application programming interface document in a cache of the receiving device before parsing the standard application programming interface document.

6. The application programming interface publishing system of claim 1, wherein the second executable program is further configured to be called by the second processor to enable the second processor to perform a following operation:
adding a default value for the application programming interface characteristic information obtained through parsing.

7. The application programming interface publishing system of claim 6, wherein the second executable program is further configured to be called by the second processor to enable the second processor to perform a following operation:
comparing the application programming interface characteristic information received by the receiving device with locally stored application programming interface characteristic information to determine whether an application programming interface corresponding to the application programming interface characteristic information changes.

8. (canceled)

9. The application programming interface publishing system of claim 7, wherein the second executable program is further configured to be called by the second processor to enable the second processor to perform a following operation:
storing the application programming interface characteristic information locally in the receiving device.

10. The application programming interface publishing system of claim 1, wherein the application program comprises at least one of a short message platform, a user center, a dormitory management system, and a message notifier.

11. An application programming interface information pushing method applied to an application device, comprising:
acquiring application programming interface characteristic information of an application program in response to a start signal of the application program;
generating a standard application programming interface document according to the application programming interface characteristic information; and
pushing the standard application programming interface document to a receiving device.

12. (canceled)

13. The pushing method of claim 11, further comprising:
stopping acquiring the application programming interface characteristic information after pushing the standard application programming interface document to the receiving device.

14. An acquisition method for application programming interface characteristic information applied to a receiving device, comprising:
filtering received information to obtain a standard application programming interface document; and
parsing the standard application programming interface document to obtain application programming interface characteristic information.

15. The acquisition method of claim 14, further comprising:
adding a default value for the application programming interface characteristic information obtained through parsing.

16. The acquisition method of claim 14, further comprising:
after obtaining the application programming interface characteristic information, comparing the application programming interface characteristic information with locally stored application programming interface characteristic information to determine whether an application programming interface corresponding to the application programming interface characteristic information changes.

17. (canceled)

18. The acquisition method of claim 16, further comprising:
persistently and locally storing the application programming interface characteristic information.

19. The acquisition method of claim 14, further comprising:
before parsing the standard application programming interface document, storing the standard application programming interface document in a cache.

20. An application programming interface publishing method applied to a service management device, comprising:
receiving application programming interface characteristic information obtained through parsing by a receiving device, wherein the application programming interface characteristic information is obtained with the acquisition method of claim 14; and
displaying the application programming interface characteristic information.

21. (canceled)

22. An application device, comprising:
a first storage module having a first executable program stored thereon; and
one or more first processors capable of calling the first executable program to perform the pushing method of claim 11.

23. A receiving device, comprising:
a second storage module having a second executable program stored thereon; and
one or more second processors capable of calling the second executable program to perform the acquisition method of claim 14.

24. A service management device, comprising:
a third storage module having a third executable program stored thereon; and
one or more third processors capable of calling the third executable program to perform the application programming interface publishing method of claim 20.
